(19) United States
(12) Patent Application Publication
(10) Pub. No.: US 2010/0098161 A1
(43) Pub. Date: Apr. 22, 2010

(54) VIDEO ENCODING APPARATUS AND VIDEO ENCODING METHOD

(75) Inventor: Michiko MIZOGUCHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/548,885

(22) Filed: Aug. 27, 2009

(30) Foreign Application Priority Data
Oct. 20, 2008 (JP) 2008-269359

(51) Int. Cl. H04N 7/26

(52) U.S. Cl. 375/240.13; 375/240.28; 375/E07.243

(57) ABSTRACT

A video encoding apparatus and method are provided. The apparatus includes a clock generation unit generating a clock, an order unit ordering start timing of the encoding. The apparatus includes a first encoding unit encoding the inputted video to generate first compressed data having a predetermined first band, synchronizes a random access point (RAP) of the first compressed data with the start timing and adds time information based on the clock to the RAP of the first compressed data and a second encoding unit encoding the inputted video to generate second compressed data having a second band narrower than the first band, synchronizes a RAP of the second compressed data with the start timing, acquires the time information of the RAP of the first compressed data and adds the time information to the RAP of the second compressed data that synchronizes with the RAP of the first compressed data.

### CROSS-REFERENCE TO RELATED APPLICATION(S)

This application is related to and claims priority to Japanese Patent Application No. 2008-269359, filed on Oct. 20, 2008 and incorporated herein by reference.

### BACKGROUND

1. Field

The embodiments discussed herein are directed to a video encoding apparatus and video encoding method for encoding inputted video.

2. Description of Related Art

Video (motion video) editing using a computer is normally performed by extracting video in units of frames, and therefore non-compressed data can be handled most easily. However, since video has a large volume of data, when consideration is given to saving of the video in a storage medium such as a disk, it is a common practice that the video is compressed and recorded. Furthermore, when video is transmitted, it is a common practice to compress the video for transmission in consideration of network bands.

Conventionally, many video editing systems handle non-compressed video data or intra-frame compressed video data that can be extracted frame by frame. However, when non-compressed or intra-frame compressed video data is HD (High Definition) video, the amount of data or the amount of processing becomes enormous.

Therefore, conventional systems adopt an inter-frame compression scheme such as MPEG (Moving Picture Experts Group) capable of high compression to perform editing while decoding and create a separate proxy file for editing if necessary and performs editing using the file.

As video transmission systems, there are systems that use inter-frame compression such as MPEG. Among such systems, there is a system in which a receiving side apparatus receives transmitted data and then processes the data by the aforementioned editing system or a system that decodes the data in real time while receiving the transmitted data and delivers the data to the editing system.

Conventionally, a compressed moving image decoding/display apparatus and an editing apparatus provide instant access to an arbitrarily specified frame of a compressed moving image stream.

### SUMMARY

It is an aspect of the embodiments discussed herein to provide a video encoding apparatus that performs video encoding includes clock generation unit that generates a clock, an order unit that orders start timing of the encoding; a first encoding unit that encodes the inputted video to generate first compressed data having a predetermined first band, synchronizes a random access point of the first compressed data with the start timing ordered by the order unit and adds time information based on the clock generated by the clock generation unit to the random access point of the first compressed data; and a second encoding unit that encodes the inputted video to generate second compressed data having a second band narrower than the first band, synchronizes a random access point of the second compressed data with the start timing ordered by the order unit, acquires the time information of the random access point of the first compressed data and adds the time information to the random access point of the second compressed data that synchronizes with the random access point of the first compressed data.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram illustrating an exemplary embodiment of a video transmission system;

FIG. 2 is a block diagram illustrating an exemplary transmission unit;

FIG. 3 is a sequence diagram illustrating exemplary operations of respective units of a video transmission unit;

FIG. 4 is a time chart illustrating exemplary picture structure in a video transmission system;

FIG. 5 is a time chart illustrating exemplary picture structure of a video transmission system;

FIG. 6 is a time chart illustrating exemplary picture structure of a video transmission system; and

FIG. 7 is a time chart illustrating exemplary picture structure of a video transmission system.

### DETAILED DESCRIPTION OF THE EMBODIMENTS

Video, handled by television or the like, is increasingly being HD-converted and the amount of video data is increasing. Intra-frame compression, which allows to cut from all video frames and thereby facilitates editing, does not provide sufficient compression and displaying video on an editing device causes a high load on the CPU (Central Processing Unit). There are editing systems that create a proxy file from compressed video data. However, creating a proxy file requires high CPU processing performance and time.

Furthermore, since video transmission requires a throughput of several Mbps even when HD video is compressed, if only part of video can be segmented and transmitted/received, the time and communication band necessary for data transmission/reception can also be reduced. However, even with the same video, necessary locations of the video differ depending on the use on the receiving side, and therefore it is difficult for the transmitting side to specify locations of the video to be segmented beforehand. Furthermore, operationally, equipment cannot be provided on the transmitting side or when no editor is available, the receiving side needs to perform editing.

There are also systems in which the transmitting side transmits a plurality of types of video data at different compression rates (video quality). In such systems, the transmitting side apparatus transmits video data with a high compression rate, the receiving side apparatus specifies frames of the video data and extracts frames of desired locations from the video data with a low compression rate (that is, video data of high quality).

Video data compressed using inter-frame compression includes frames whose decoding requires the use of data of the preceding or following frame and frames that can be decoded using only data in one frame. It is frames that can be decoded with only data in one frame that can be specified as the start position of group of pictures. That is, a frame that can be decoded with only data in one frame can serve as a random access point. Since positions at which random access points appear in high compressed video data and low compressed video data are not synchronized with each other, it is not possible to extract a frame at exactly the same timing as a frame specified with high compressed video data from low compressed video data. For example, many real-time video encoding apparatuses used in video transmission have a picture structure grouped by 500 ms, and therefore clipping points of a plurality of pieces of compressed data may be shifted by several hundreds of ms.

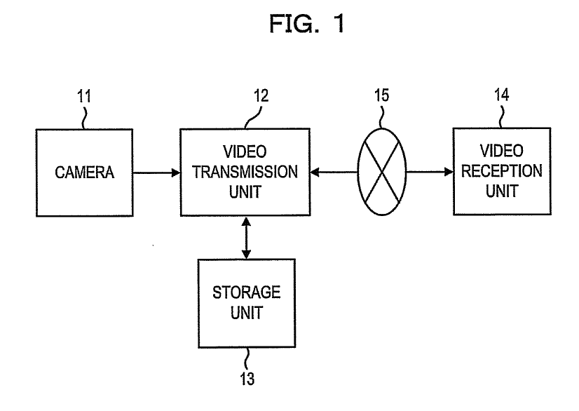

FIG. 1 is a block diagram illustrating a video transmission system according to an exemplary embodiment. This video transmission system includes a camera 11, a video transmission unit 12 (video encoding apparatus), a storage unit 13 and a video reception unit 14. The video transmission section 12 and video reception unit 14 may be connected together via a network 15.

A video source and audio source generated by the camera 11 are inputted to the video transmission unit 12. The video source is data of an image taken by the camera 11 and the audio source is data recorded by the camera 11.

The video transmission unit 12 may perform two types of compression on the video source and audio source simultaneously. The two types of compressed data obtained in this way are high quality data having compressed video data of a high bit rate that satisfies quality required for a video material of, for example, TV broadcasting (first compressed data) and proxy data having compressed video data of a low bit rate (second compressed data). The compressed video data of a high bit rate can be expressed as broadband data or high quality data or low compressed data. The compressed video data of a low bit rate can be expressed as narrow band data or low quality data or high compressed data.

The proxy data has compressed video data on the order of, for example, several hundreds of kbps and is transmitted to the video reception unit 14 at a remote place in real time via the network 15. Furthermore, the video transmission unit 12 saves the proxy data and high quality data in the storage unit 13 simultaneously. Therefore, the video transmission unit 12 can also transmit the data to the video reception unit 14 later. The storage unit 13 may be a storage apparatus.

The video reception unit 14 may be a PC (Personal Computer) and executes an editing program. Furthermore, the video reception unit 14 saves received data, decodes the received data, displays the decoded video and audio data, specifies a frame in the displayed video or the like according to the editing program.

The video reception unit 14 which has received the proxy data decodes and displays the received proxy data. The user browses the proxy data displayed by the video reception unit 14 and specifies a frame in the proxy data. When the frame is specified, the video reception unit 14 sends a request (specification information) of high quality data from the start frame onward to the video transmission unit 12 using the frame as a start frame. The video transmission unit 12 which has received the request transmits the high quality data from the start frame onward to the video reception unit 14. The video reception unit 14 which has received the high quality data decodes and displays the received high quality data.

Furthermore, two frames specified by the user in the proxy data displayed on the video reception unit 14 may also be used as a start frame and end frame. In such a case, the video reception unit 14 transmits a request for high quality data from the start frame to the end frame to the video transmission unit 12. The video transmission unit 12 which has received the request transmits the high quality data from the start frame to the end frame to the video reception unit 14.

Furthermore, using one frame specified by the user in the proxy data displayed on the video reception unit 14 as the start frame, the user may further enter specification of a time length. In such a case, the video reception unit 14 transmits a request for high quality data corresponding to the time length from the start frame to the video transmission unit 12. The video transmission unit 12 which has received the request transmits high quality data corresponding to the time length from the start frame to the video reception unit 14.

Here, the compressed video data is data compressed based on an inter-frame encoding scheme. An example of the inter-frame encoding scheme is MPEG. The picture structure of compressed video data uses GOP (Group Of Pictures) as a unit and can include an I (Intra-coded) frame in each GOP and further P (Predicted) frame and B (Bi-directional Predicted) frame.

Furthermore, a random access point (RAP) which is a point that can be specified by the user as the start frame or end frame is an I frame (Intra-coded Frame). When only the start frame is specified, the video transmission unit 12 transmits high quality data from GOP onward of the start frame to the video reception unit 14. When the start frame and end frame are specified, the video transmission unit 12 transmits high quality data from GOP of the start frame up to GOP immediately before the end frame to the video reception unit 14.

The high quality data has on the order of, for example, several Mbps and frames from the specified frame onward are transmitted from the video transmission unit 12 to the video reception unit 14. In this way, the network 15 can be efficiently used by transmitting only the necessary portion of the high quality data.

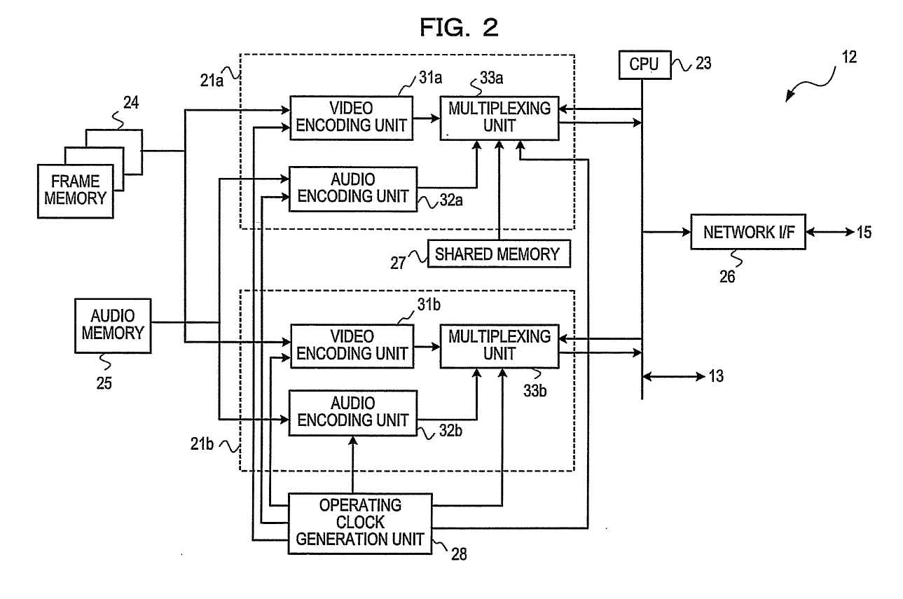

FIG. 2 is a block diagram illustrating a video transmission unit according to an exemplary embodiment. The video transmission unit 12 includes an encoder 21a (second encoding unit), 21b (first encoding unit), a CPU 23 (order unit), a frame memory 24, an audio memory 25, a network I/F (interface) 26 (transmission unit and reception unit), a shared memory 27 (storage unit) and an operating clock generation unit 28 (clock generation unit).

The CPU 23 controls the encoders 21a and 21b. The frame memory 24 has a ring-buffer-like configuration in frame units and stores a video source of a plurality of frames. The audio memory 25 stores an audio source. The network I/F 26 transmits compressed data stored in the storage unit 13 and receives a request for compressed data via the network 15. The shared memory 27 stores information on time stamps. This information is written by the encoder 21b and read by the encoder 21a.

The encoders 21a and 21b may be a DSP (Digital Signal Processor), operate according to the CPU 23 independently, compress sources and generate compressed data having different compression rates (bands).

The encoder 21a includes a video encoding unit 31a, an audio encoding unit 32a and a multiplexing unit 33a. The video encoding unit 31a compresses a video source stored in the frame memory 24 and generates compressed video data. The audio encoding unit 32a compresses an audio source stored in the audio memory 25 and generates compressed audio data. The multiplexing unit 33a multiplexes the compressed video data and the compressed audio data, and generates compressed data.

The encoder 21b includes a video encoding unit 31b, an audio encoding unit 32b and a multiplexing unit 33b. The video encoding unit 31b, audio encoding unit 32b and multiplexing unit 33b are hardware similar to that of the above described video encoding unit 31a, audio encoding unit 32a and multiplexing unit 33a respectively. However, the encoders 21a and 21b may have different set values given by the CPU 23.

The operating clock generation unit 28 supplies operating clocks to the video encoding units 31 and the audio encoding unit 32 of the encoders 21a and 21b and the multiplexing units 33.

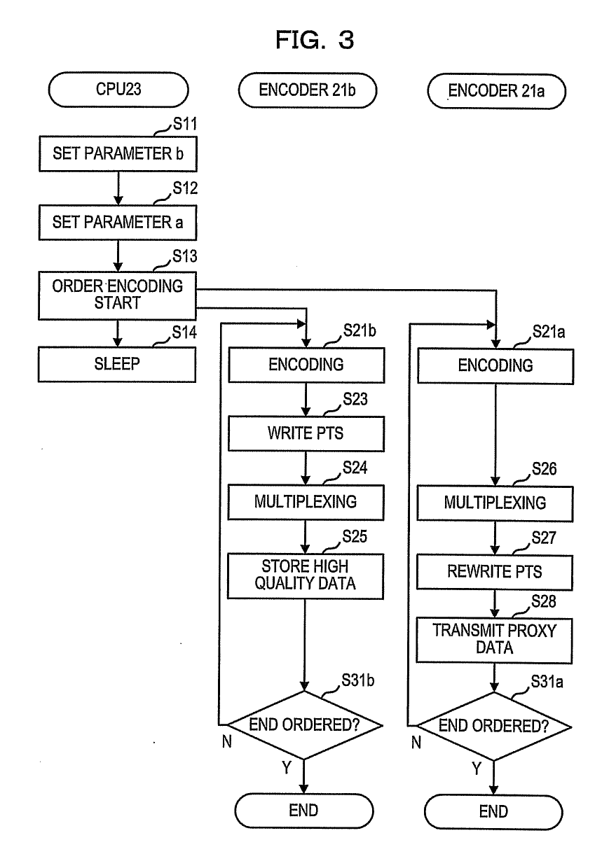

FIG. 3 is a sequence diagram illustrating units of the video transmission unit 12 according to an exemplary embodiment. This sequence diagram illustrates a time flow from the top to bottom and illustrates operations of the CPU 23, encoder 21b and encoder 21a, in that order, from the left.

The CPU 23 sets a compression parameter b in the encoder 21b (S11) and sets a compression parameter a in the encoder 21a (S12). The compression parameter a has a frame rate Fa and the number of GOP frames Ga. Likewise, the compression parameter b has a frame rate Fb and the number of GOP frames Gb.

The parameter b is a parameter for generating high quality data and the parameter a is a parameter for generating proxy data. Furthermore, the frame rate of the parameter b is an integer multiple of the frame rate of the parameter a. Furthermore, the number of GOP frames of the parameter b is an integer multiple of the number of GOP frames of the parameter a.

The CPU 23 orders the encoders 21a and 21b to start encoding (S13) and goes into sleep mode (S14).

The video encoding unit 31b which has received the order to start encoding performs encoding on the video source based on timing of a synchronization signal for each frame at the video source from the camera 11 and an operating clock from the operating clock generation unit 28 and generates compressed video data (S21b). Here, the video encoding unit 31b takes in a frame from the frame memory 24 at timing of the synchronization signal. Furthermore, the video encoding unit 31b adds a PTS (Presentation Time Stamp) or time code based on the count value of the operating clock to the compressed video data.

At the same time, the audio encoding unit 32b performs encoding on the audio source according to the operating clock from the operating clock generation unit 28 and generates compressed audio data.

At the same time, the video encoding unit 31a which has received an order to start encoding performs encoding on the video source based on timing of a synchronization signal for each frame in the video source from the camera 11 and operating clock from the operating clock generation unit 28 and generates compressed video data (S21a).

At the same time, the audio encoding unit 32a performs encoding on the audio source according to the operating clock from the operating clock generation unit 28 and generates compressed audio data.

Upon receiving the order to start encoding, the video encoding units 31a and 31b always start encoding from an I frame.

The multiplexing unit 33b writes a PTS added to compressed data and an I frame flag indicating whether or not the frame is an I frame into the shared memory 27 (S23). The multiplexing unit 33b multiplexes (system multiplexing) the compressed video data generated by the video encoding unit 31b and the compressed audio data generated by the audio encoding unit 32b and generates high quality data which is compressed data (S24). The multiplexing unit 33b stores the high quality data generated in the storage unit 13 (S25).

The multiplexing unit 33a multiplexes (system multiplexing) the compressed video data generated by the video encoding unit 31a and the compressed audio data generated by the audio encoding unit 32a and generates proxy data which is compressed data (S26). The multiplexing unit 33a reads the PTS and I frame flag stored in the shared memory 27 and rewrites the PTS of the proxy data with the PTS read from the shared memory 27 (S27). The multiplexing unit 33a specifies the frame of the proxy data that synchronizes with the read frame based on the read I frame flag and I frame flag of the proxy data and rewrites the PTS. The network I/F 26 transmits the proxy data rewritten by the multiplexing unit 33a to the video reception unit 14 (S28).

Even when different PTSs are added to the high quality data and proxy data, the multiplexing unit 33a rewrites the PTSs, and can thereby make identical the PTSs between the corresponding frames of the high quality data and proxy data.

The video encoding unit 31b judges whether or not an order to end encoding has been received (S31b). When an order to end encoding has not been received (S31b, N), this flow returns to process S21b. When an order to end encoding has been received (S31b, Y), this flow ends.

Likewise, the video encoding unit 31a judges whether or not an order to end encoding has been received (S31a). When an order to end encoding has not been received (S31a, N), this flow returns to process S21a. When an order to end encoding has been received (S31a, Y), this flow ends.

The video encoding unit 31a may read the PTS and I frame flag stored in the shared memory 27 and add the PTS read from the shared memory 27 as the PTS of the proxy data that synchronizes therewith.

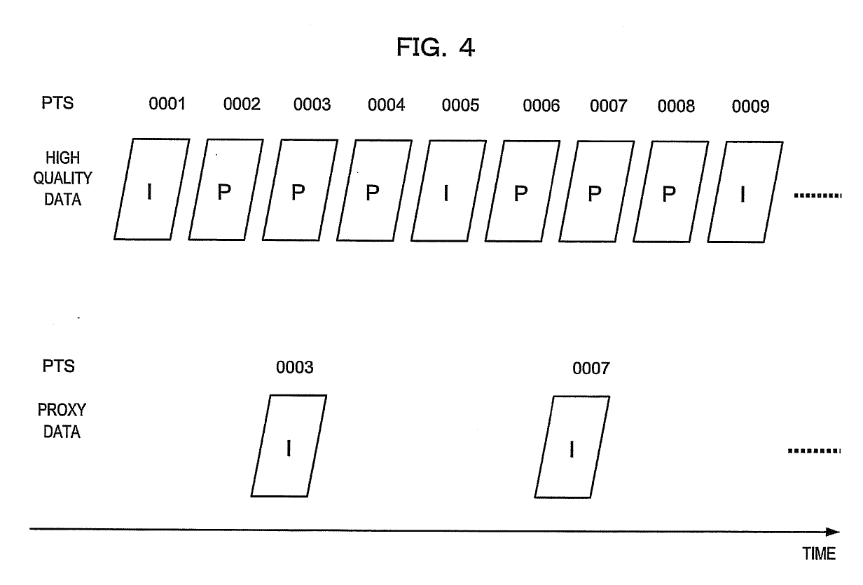

FIG. 4 is a time chart illustrating an example of a picture structure in a video transmission system to which an exemplary embodiment is not applied. In this chart, the upper row shows a PTS and picture structure of high quality data and the lower row shows a PTS and picture structure of proxy data. Furthermore, the horizontal axis of this chart denotes a time scale. Alphabetical letters written in each frame of the picture structure denote the type of I frame or P frame. As an example, if the number of GOP frames of high quality data is 4, the frame rate of high quality data is 8 fps, the number of GOP frames of proxy data is 1 and the frame rate of the proxy data is 2 fps. That is, the GOP time length of the high quality data is equal to the GOP time length of the proxy data, which is 500 msec.

As illustrated in FIG. 4, in the video transmission system to which an exemplary embodiment is not applied, the time at which an image of the I frame of the proxy data is taken may be different from the time at which an image of the I frame of the high quality data thereby specified is taken.

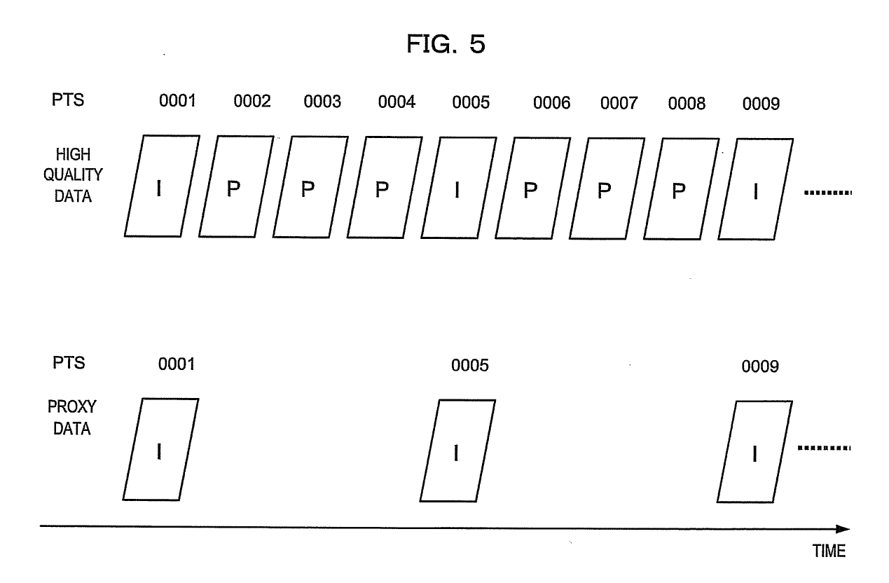

FIG. 5 is a time chart illustrating a picture structure in a video transmission system of an exemplary embodiment. In this chart, the upper row shows a PTS and picture structure of high quality data and the lower row shows a PTS and picture structure of proxy data. Furthermore, the horizontal axis in this chart denotes a time scale. In the picture structure, alphabetical letters written in each frame denote the type of I frame or P frame. As an example, a number of GOP frames of high quality data is 4, the frame rate of high quality data is 8 fps, the number of GOP frames of proxy data is 1 and the frame rate of the proxy data is 2 fps. That is, the GOP time length of the high quality data is equal to the GOP time length of the proxy data, which is 500 msec.

In the first example of the picture structure, the time at which an image of the I frame of the proxy data is taken is equal to the time at which an image of the I frame of high quality data thereby specified is taken, and the proxy data and high quality data are synchronized with each other.

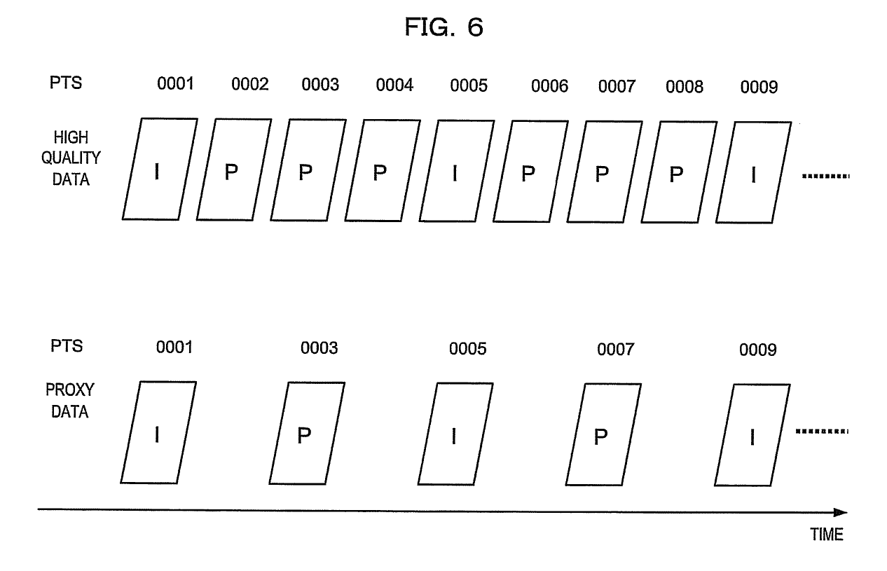

FIG. 6 is a time chart illustrating a picture structure in a video transmission system of an exemplary embodiment. In this chart, the upper row shows a PTS and picture structure of high quality data and the lower row shows a PTS and picture structure of proxy data. Furthermore, the horizontal axis in this chart denotes a time scale. In the picture structure, alphabetical letters written in each frame denote the type of I frame or P frame. As an example, a number of GOP frames of high quality data is 4, the frame rate of high quality data is 8 fps, the number of GOP frames of proxy data is 2 and the frame rate of the proxy data is 4 fps. That is, the GOP time length of the high quality data is equal to the GOP time length of the proxy data, which is 500 msec.

In the second example of the picture structure, the time at which an image of the I frame of the proxy data is taken is equal to the time at which an image of the I frame of high quality data thereby specified is taken, and the proxy data and high quality data are synchronized with each other.

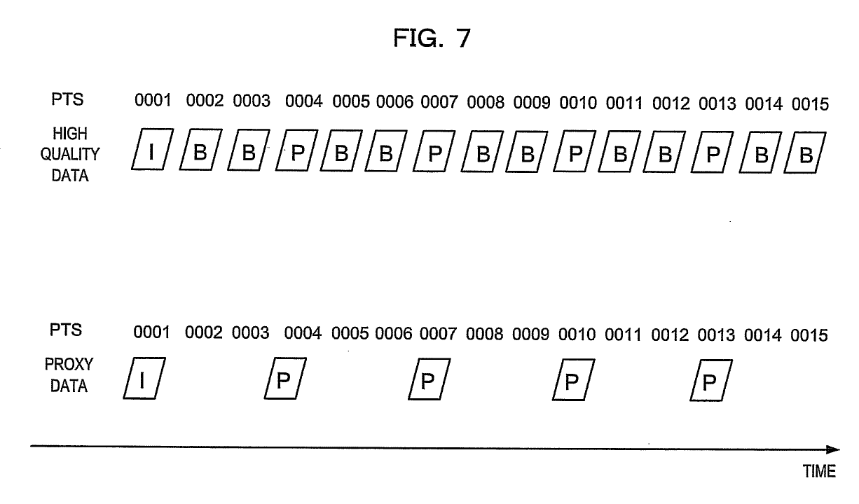

FIG. 7 is a time chart illustrating another example of a picture structure of a video transmission system of an exemplary embodiment. In this chart, the upper row shows a PTS and picture structure of high quality data and the lower row shows a PTS and picture structure of proxy data. Furthermore, the horizontal axis in this chart shows a time scale. Alphabetical letters written in each frame in the picture structure denote the type of I frame (Intra-coded Frame) or P frame (Predicted Frame) or B frame (Bi-directional predicted Frame). As an example, a number of GOP frames of the high quality data is 15, the frame rate of the high quality data is 30 fps, the number of GOP frames of the proxy data is 5 and the frame rate of the proxy data is 10 fps. That is, the GOP time length of the high quality data is equal to the GOP time length of the proxy data, which is 500 msec.

In the third example of the picture structure, the picture structure of the proxy data includes P frames in addition to I frames. Since the encoder 21a includes P frames and B frames in the proxy data, the proxy data is displayed with the capacity thereof suppressed, at a high frame rate and smoothly. Increasing the frame rate of the proxy data in this way allows the proxy data to also serve for audio/visual use.

In the third example of the picture structure, the time at which an image of the I frame of the proxy data is taken is equal to the time at which an image of the I frame of the high quality data thereby specified is taken, and the proxy data and high quality data are synchronized with each other.

An exemplary embodiment allows the video reception unit 14 (reception point) located away from the camera 11 (image taking point) and video transmission unit 12 (transmission point) to accurately specify a start frame of high quality data using proxy data.

An exemplary embodiment creates proxy data for segmenting video in real time, and can thereby efficiently perform transmission or editing of high quality data. An exemplary embodiment can accurately associate timings of two types of compressed data having different bands. That is, an exemplary embodiment allows PTSs and random access points (RAP) of high quality data and proxy data to be synchronized with each other at the time of video compression. Therefore, the receiving side apparatus which has received data generated in an exemplary embodiment can perform editing without the need to search mega high quality data or create a reference table indicating RAPs. Furthermore, use of synchronized proxy data in video transmission allows high quality data of only necessary portions to be transmitted accurately. Thus, it is possible to specify accurate frames and also perform video editing from a remote place, and an exemplary embodiment can also be applied to a video transmission system.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A video encoding apparatus that performs video encoding, comprising:
a clock generation unit that generates a clock;
an order unit that orders start timing of the encoding;
a first encoding unit that encodes the inputted video to generate first compressed data having a predetermined first band, synchronizes a random access point of the first compressed data with the start timing ordered by the order unit and adds time information based on the clock generated by the clock generation unit to the random access point of the first compressed data; and
a second encoding unit that encodes the inputted video to generate second compressed data having a second band narrower than the first band, synchronizes a random access point of the second compressed data with the start timing ordered by the order unit, acquires the time information of the random access point of the first compressed data and adds the time information to the random access point of the second compressed data that synchronizes with the random access point of the first compressed data.

2. The video encoding apparatus according to claim 1, wherein the first encoding unit generates random access points at predetermined time intervals in the first compressed data, and
the second encoding unit generates random access points at the predetermined time intervals in the second compressed data.

3. The video encoding apparatus according to claim 2, wherein the number of frames of the first compressed data at the predetermined time intervals is a plurality of times the number of frames of the second compressed data at the predetermined time intervals.

4. The video encoding apparatus according to claim 1, further comprising a storage unit that stores the time information,
wherein the first encoding unit generates the first compressed data, adds time information based on the clock generated by the clock generation unit to the random access point of the first compressed data and stores the time information in the storage unit, and
the second encoding unit reads the time information of the random access point of the first compressed data stored in the storage unit and adds the time information to the random access point of the second compressed data that synchronizes with the random access point.

5. The video encoding apparatus according to claim 1, further comprising a storage unit that stores the time information,
wherein the first encoding unit generates the first compressed data, adds time information based on the clock generated by the clock generation unit to the random access point of the first compressed video data and stores the time information in the storage unit, and
the second encoding unit generates the second compressed data, adds time information based on the clock generated by the clock generation unit to the random access point of the second compressed video data, reads the time information of the random access point of the first compressed data stored in the storage unit and rewrites the time information of the random access point of the second compressed data that synchronizes with the random access point with the time information read from the storage unit.

6. The video encoding apparatus according to claim 4, further comprising:
a transmission unit that transmits the second compressed data generated by the second encoding unit to an outside decoding apparatus; and
a storage unit that stores the first compressed data generated by the first encoding unit.

7. The video encoding apparatus according to claim 6, further comprising a reception unit that receives specification information which is information specifying at least one random access point from the decoding apparatus,
wherein when the reception unit receives the specification information specifying a random access point of a start point, the transmission unit transmits the first compressed data from the start point specified by the specification information onward.

8. The video encoding apparatus according to claim 6, wherein when the reception unit receives the specification information specifying the random access point of the start point and the random access point of the end point, the transmission unit transmits the first compressed data from the start point to the end point specified by the specification information.

9. The video encoding apparatus according to claim 1, wherein the first encoding unit generates the first compressed data based on a predetermined inter-frame encoding scheme, and
the second encoding unit generates the second compressed data based on the predetermined inter-frame encoding scheme.

10. The video encoding apparatus according to claim 9, wherein the time length of GOP of the first compressed data is equal to the time length of GOP of the second compressed data.

11. The video encoding apparatus according to claim 9, wherein GOP of the first compressed data comprises intra-frame encoded frames and inter-frame encoded frames, and
GOP of the second compressed data comprises only intra-frame encoded frames.

12. A video encoding method for encoding video using a computer, comprising:
ordering start timing of the encoding;
encoding the inputted video to generate first compressed data having a predetermined first band, synchronizing a random access point of the first compressed data with the ordered start timing and adding time information based on a clock generated by a clock generation unit to the random access point of the first compressed data; and
encoding the inputted video to generate second compressed data having a second band narrower than the first band, synchronizing a random access point of the second compressed data with the ordered start timing, acquiring the time information of the random access point of the first compressed data and adding the time information to the random access point of the second compressed data that synchronizes with the random access point of the first compressed data.

13. The video encoding method according to claim 12, comprising:
generating random access points at predetermined time intervals for the first compressed data; and
generating random access points at the predetermined time intervals for the second compressed data.

14. The video encoding method according to claim 13, wherein the number of frames of the first compressed data at the predetermined time intervals is a plurality of times the number of frames of the second compressed data at the predetermined time intervals.

15. The video encoding method according to claim 12, comprising:
generating the first compressed data, adding time information based on the clock generated by the clock generation unit to the random access point of the first compressed data and storing the time information in the storage unit; and
reading the time information of the random access point of the first compressed data stored in the storage unit and adding the time information to the random access point of the second compressed data that synchronizes with the random access point.

16. The video encoding method according to claim 12, comprising:
generating the first compressed data, adding time information based on the clock generated by the clock generation unit to the random access point of the first compressed video data and storing the time information in the storage unit; and
generating the second compressed data, adding time information based on the clock generated by the clock generation unit to the random access point of the second compressed video data, reading the time information of the random access point of the first compressed data stored in the storage unit and rewriting the time information of the random access point of the second compressed data that synchronizes with the random access point with the time information read from the storage unit.

17. The video encoding method according to claim 16, further comprising:
transmitting the second compressed data to an outside decoding apparatus; and
storing the first compressed data.

18. The video encoding method according to claim 17, further comprising receiving specification information which is information specifying at least one random access point from the decoding apparatus,
wherein when the specification information specifying a random access point of a start point is received, the first compressed data is transmitted from the start point specified by the specification information onward.

19. The video encoding method according to claim 18, wherein when the specification information specifying the random access point of the start point and the random access point of the end point is received, the first compressed data from the start point to the end point specified by the specification information is transmitted.

20. An encoding apparatus, comprising:
an order unit capable of starting a timing of an encoding;
a first encoding unit that encodes an input to generate first compressed data having a first band, synchronizes a random access point of the first compressed data with the ordered start timing and adds time information to the random access point; and
a second encoding unit that encodes the input to generate second compressed data having a second band narrower than the first band, synchronizes a random access point of the second compressed data with the start timing, acquires the time information of the random access point of the first compressed data and adds the time information to the random access point of the second compressed data that synchronizes with the random access point of the first compressed data.
